(19) United States
(12) Patent Application Publication
(10) Pub. No.: US 2002/0180693 A1
(43) Pub. Date: Dec. 5, 2002

(54) Computer input device having heating and/or vibrating elements

(76) Inventor: Brett J. Muir, Pacifica, CA (US)

Correspondence Address: ERIC B. MEYERTONS, CONLEY, ROSE & TAYON, P.C., P.O. BOX 398, AUSTIN, TX, 78767-0398, US

(21) Appl. No.: 09/874,426

(22) Filed: Jun. 4, 2001

(51) Int. Cl. G09G 5/00

(52) U.S. Cl. 345/156

(57) ABSTRACT

Computer input devices configured to provide heat and/or vibrational energy to the user are disclosed. Heat and/or vibrational energy from such input devices may be manually controlled by the user. In some cases, heat and/or vibrational energy from such input devices may be automatically controlled by a microcontroller or computer.

### BACKGROUND OF THE INVENTION

1. Field of the Invention

Embodiments disclosed herein generally relate to computer input devices.

2. Description of Related Art

Computer use has become an important productivity improvement tool in the United States and throughout the world. In general, it would be difficult to imagine the operation of a business without the predominant use of computers. Internet-based commerce, often referred to as e-commerce, has provided further impetus to the widespread use of a computer in home and in the business.

It is not uncommon for a person to work with a computer for a majority of a workday. Professionals such as Graphic designers, secretaries, software engineers, attorneys, and the like may provide inputs to a computer by actuating a stationary mouse (commonly called a trackball), or by actuating a movable mouse by sliding it about a planar surface. Continuous operation of such a device over a substantial period of time may result in fatigue and discomfort. Such fatigue and discomfort may result in absenteeism and/or in decreased productivity. Furthermore, the widespread proliferation of devices such as a computer mouse or keyboard has contributed to a significant increase in incidences of a repetitive motion stress injury, known as carpal tunnel syndrome.

Carpal tunnel syndrome may be a serious medical condition. Carpal tunnel syndrome may result in permanent nerve or joint damage. Symptoms of carpal tunnel syndrome may include tingling, numbness, or pain in a sufferer's hand or wrist. It is known that such tingling, numbness, and pain comes from compression of the median nerve when the carpal ligaments move in a repetitive fashion, over a period of time, through the carpal tunnel in the wrist.

The following U.S. patents generally describe mouse type input devices, heated computer pads, and hand held vibrating devices: U.S. Pat. Nos. 5,686,005 to Wright, Sr.; 6,135,399 to Savoie et al.; 6,039,702 to Cutler et al.; 6,077,238 to Chung; 6,094,190 to Kodim; and 6,011,543 to Tian, all of which are incorporated herein by reference.

### SUMMARY OF THE INVENTION

Embodiments disclosed herein relate to computer input peripheral devices configured to provide heat and/or vibrational energy to the hand and/or wrist of a user. In an embodiment, a computer input device may be configured to provide heat and/or vibrational energy to the user. The magnitude of the heat and/or vibrational energy provided to the user may be controlled by the user. In an embodiment, the magnitude of the heat and/or vibrational energy provided to the user may be controlled by a microprocessor, or a computer the input device is coupled to.

An advantage of embodiments disclosed herein may be that providing heat and/or vibrational energy to a user may stimulate circulation in the user's hand and/or wrist. It is believed that providing heat and/or vibration energy to a user may reduce discomfort associated with repetitive motion injuries. It is believed that increased circulation in the hand and/or wrist of a repetitive motion stress injury suffer may promote healing of the injury.

### BRIEF DESCRIPTION OF THE DRAWINGS

Further advantages of the present invention will become apparent to those skilled in the art with the benefit of the following detailed description of embodiments and upon reference to the accompanying drawings wherein:

FIG. 1 is a schematic view of an embodiment of a computer system;

FIG. 2 is a perspective view of an embodiment of a mouse having manual controls on the side;

FIG. 3 is a partially exploded side perspective view of an embodiment of a heating element;

FIG. 4 is a schematic view of an embodiment of an input device;

FIG. 5 is a schematic view of an embodiment of an input device; and

FIG. 6 is a partial cut away top schematic view of an embodiment of a keyboard with the body of the keyboard in shadow.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION OF THE PREFERRED EMBODIMENTS

The term “computer system” as used herein generally describes the hardware and software components that in combination allow the execution of computer programs. The computer programs may be implemented in software, hardware, or a combination of software and hardware. A computer system's hardware generally includes a processor, memory media, and input/output (I/O) devices. As used herein, the term “processor” generally describes the logic circuitry that responds to and processes the basic instructions that operate a computer system. The term “memory medium” includes an installation medium, e.g., a CD-ROM, floppy disks; a volatile computer system memory such as DRAM, SRAM, EDO RAM, Rambus RAM, etc.; or a non-volatile memory such as optical storage or a magnetic medium, e.g., a hard drive. The term “memory” is used synonymously with “memory medium” herein. The memory medium may comprise other types of memory or combinations thereof. In addition, the memory medium may be located in a first computer in which the programs are executed, or may be located in a second computer that connects to the first computer over a network. In the latter instance, the second computer provides the program instructions to the first computer for execution. In addition, the computer system may take various forms, including a personal computer system, mainframe computer system, workstation, network appliance, Internet appliance, personal digital assistant (PDA), television system or other device. In general, the term “computer system” can be broadly defined to encompass any device having a processor that executes instructions from a memory medium.

The memory medium preferably stores a software program or programs for the reception, storage, analysis, and transmittal of information produced by an Analyte Detection Device (ADD). The software program(s) may be implemented in any of various ways, including procedure-based techniques, component-based techniques, and/or object-oriented techniques, among others. For example, the software program may be implemented using ActiveX controls, C++ objects, JavaBeans, Microsoft Foundation Classes (MFC), or other technologies or methodologies, as desired.

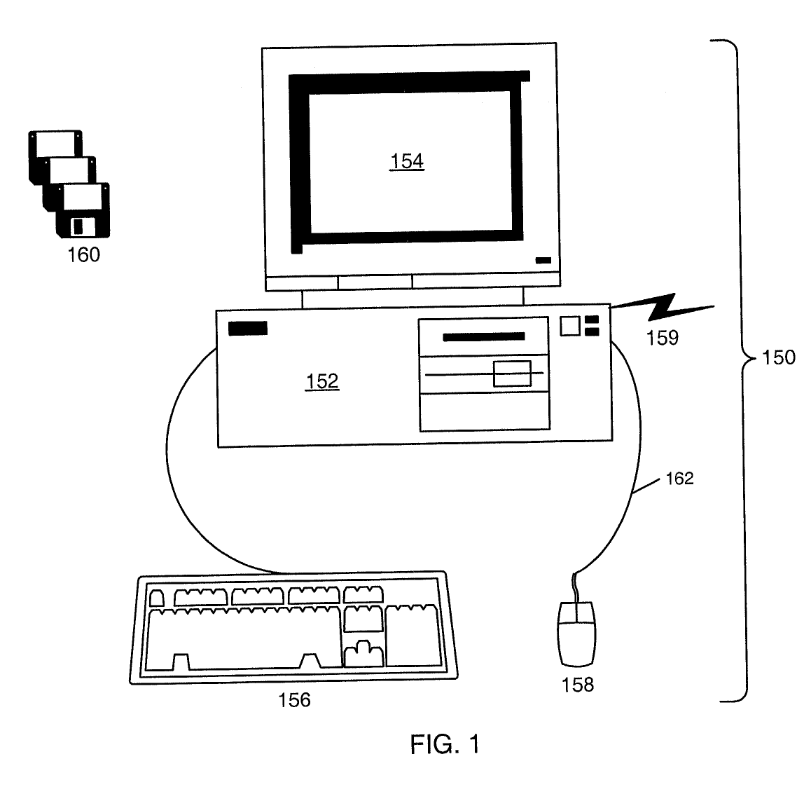

FIG. 1 depicts an embodiment of a computer system 150. Computer system 150 may include components such as a CPU 152 with an associated memory medium such as floppy disks 160, CD-ROMs, or hard disk (not shown). Computer system 150 may further include a display device such as monitor 154. Additionally computer system 150 may include one or more input devices such as a keyboard 156, mouse 158, trackball (not shown), or joystick (not shown).

Generally, heat energy may be produced by a heating element. A heating element may include a resistor configured such that when an electric current passes through the resistor heat energy is generated. The amount of heat energy generated may be computed by: Q=I²*R*T, where Q is the heat energy, I is the current, R is the resistance, and T is the amount of time for which the current flows. Thus, the amount of heat generated by a resistive heating element may be controlled by controlling the current. The amount of heat generated by a resistive heating element may also be controlled by controlling the resistance of the element. The amount of heat generated by a resistive heating element may also be controlled by controlling the amount of time that current is applied to the element. The temperature of the heating element may not increase indefinitely. The heating element may eventually reach a steady-state condition. In such a steady-state condition the rate of heat dissipation from the heating element may equal the rate of generation of heat.

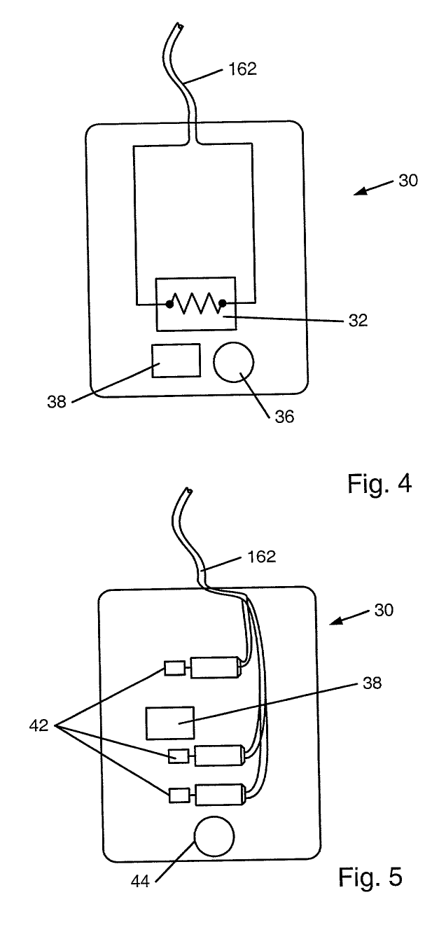

In an embodiment as depicted in FIG. 4, an input device 30 may include one or more heating elements 32. Heat energy generated by passing a current through heating element 32 may be utilized to raise the temperature of input device 30.

Input device 30 may include cable 162. Cable 162 may include at least one conductor, to electrically couple input device 30 to computer system 150. In an embodiment, cable 162 may include additional conductors. The additional conductors may be electro-magnetically shielded, and/or electrically isolated from the conductor carrying input signals from input device 30 to computer system 150. The additional conductors may be used to supply power from computer system 150 to heater element 32. In some embodiments, the same conductor or conductors may be used to provide both power to heater element 32, and input signals from input device 30 to computer system 150. For example, an input signal from input device 30 to computer system 150 may be electrically superimposed on a signal providing power to heating element 32. In an embodiment, heater element 32 may be provided with a source of power external to computer system 150. Computer system 150 may be configured to control such an external power source.

In an embodiment, input device 30 may be configured to attain a temperature selectable by a user. The selection of a particular temperature for input device 30 by the user may vary due to factors such as personal preferences, comfort level, and ambient temperature. In an embodiment, input device 30 may be configured to allow a user to select a temperature between about 70 degrees and about 120 degrees Fahrenheit.

In an embodiment, heating element 32 may be centralized in input device 30.

“Centralized” may be defined as located in a relatively small portion of input device 30. A centralized heating element may include a single resistor or several adjacent resistors. In an embodiment, heating element 32 may be distributed in input device 30.

“Distributed” may mean spread over a relatively large portion of input device 30, or located at two or more discrete locations in input device 30. A distributed heating element may include a plurality of elements electrically coupled to each other. An advantage of a distributed heating element may be that it may provide a more uniform temperature profile for input device 30.

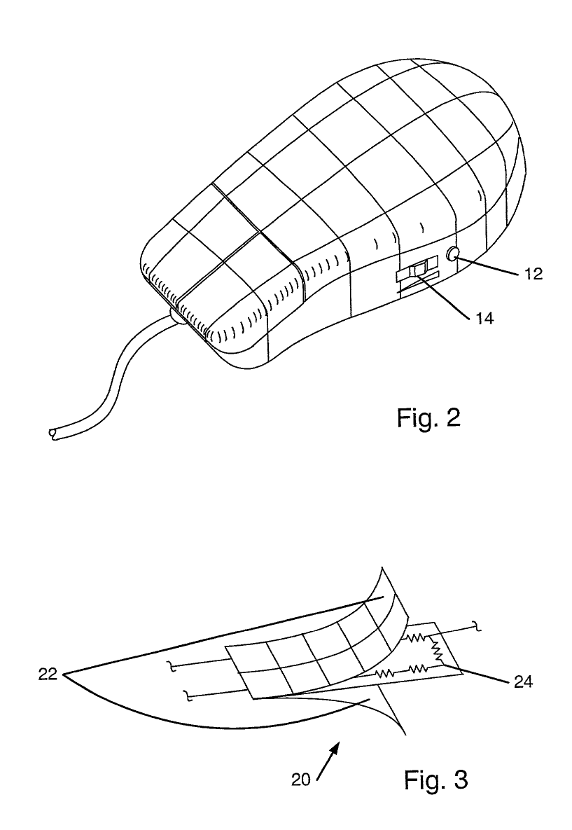

In an embodiment, heating element 32 may be constructed of commercially available products. For example, Johanson D M S, Inc. of New Smyrna Beach, Fla. manufactures a heating element 20 as depicted in FIG. 3. Heating element 20 may include two sheets of thin polymer film 22 with heating element 24 positioned between. In an embodiment, heating element 20 may be coupled input device 30. In some embodiments, a thin sheet of a heat reflective material may be included under a heating element to improve the efficiency of heat transfer. It is understood that other heating elements known in the art may be suitable for use in input device 30 to provide heat to a user.

In an embodiment (an example of which is depicted in FIG. 2), the input device may include a switch 12 to turn the heating element(s) on or off. The input device may also include an external control device 14 (e.g., a rheostat) to allow the user to control the flow of current through heating element 32, and thus the heat produced by the input device. In an embodiment, a temperature sensor 36 may be coupled to microcontroller 38. In such an embodiment, microcontroller 38 may be configured to automatically control the temperature of input device 30. In an embodiment, temperature sensor 36 may send an electrical signal to computer system 150. The electrical signal may correspond to the temperature of input device 30. In an embodiment, computer system 150 may be configured to detect the use of input device 30. For example, where input device 30 is a mouse or trackball, computer system 150 may detect motion of the mouse or trackball. In a case where input device 30 is a keyboard, computer system 150 may detect pressing of one or more keys on the keyboard. When the use of input device 30 is detected, computer system 150 may send a signal to turn on heating element 32. Turning on heating element 32 may be defined as applying or regulating electrical current applied to heating element 32. In an embodiment, microcontroller 38 may be configured to detect the use of input device 30. In such an embodiment, microcontroller 38 may send a signal to turn on heating element 32 when the use of input device 30 is detected.

In an embodiment, computer system 150 may be provided with a computer software program configured to control the temperature of input device 30. Computer system 150 may be coupled to input device 30 via cable 162. Computer system 150 may execute the computer software program to control the temperature of input device 30. In an embodiment, the computer software program may generate a graphical user interface. The graphical user interface may be configured to display the temperature of input device 30. The graphical user interface may include a color graphic display on display monitor 154. The graphical user interface may include the present temperature of input device 30. In an embodiment, the graphical user interface may include a desired or target temperature of input device 30.

In an embodiment, the software program to control the temperature of input device 30 may be based on a simple on/off control. In an embodiment, the software program to control the temperature of input device 30 may be based proportional/integral/derivative (PID) control. It is understood that other control algorithms (e.g. algorithms based on proportional control, fuzzy logic, adaptive controls, etc) may also be used.

Generally, a vibrating element may generate vibrations when electric current is passed through the vibrating element. For example, a vibrating element may include an electric motor with an eccentric mass element. When a current is passed through the motor, rotation of the eccentric mass may generate vibrational energy. A vibrating element may also include a solid-state electrical device configured to transform electrical energy into vibrational energy. For example, a piezoelectric transformer may be used to convert electrical energy into vibrational energy. In some embodiments, the magnitude of the vibration energy generated by a vibrating element may be controlled by varying the current passed through the vibrating element. The magnitude of the vibration energy generated may also be controlled by varying the physical arrangement of the vibrating element. For example, the eccentricity of the mass distribution of a mass coupled to a motor may be varied.

In an embodiment depicted in FIG. 5, input device 30 may include one or more vibrating elements 42. Vibration energy may be generated by passing a current through vibrating element 42. Such vibration energy may be transferred to a hand and/or wrist of a user of input device 30 by contact. The construction of input device 30 may be of a rugged design to withstand the vibrations generated by vibrating element 42.

Input device 30 may include cable 162. Cable 162 may include at least one conductor, to electrically couple input device 30 to computer system 150. In an embodiment, cable 162 may include additional conductors. The additional conductors may be electro-magnetically shielded, and/or electrically isolated from the conductor carrying input signals from input device 30 to computer system 150. The additional conductors may be used to supply power from computer system 150 to vibrating element 42. In some embodiments, the same conductor or conductors may be used to provide both power to vibrating element 42, and input signals from input device 30 to computer system 150. For example, an input signal from input device 30 to computer system 150 may be electrically superimposed on a signal providing power to vibrating element 42. In an embodiment, vibrating element 42 may be provided with a source of power external to computer system 150. Computer system 150 may be configured to control such an external power source.

In an embodiment, input device 30 may be configured to attain a vibration frequency and/or amplitude selectable by a user of input device 30. The selection of a particular vibration setting for input device 30 by a user may vary on factors such as personal preferences, and comfort level.

In an embodiment, vibrating element 42 may be centralized in input device 30. In an embodiment, vibrating element 42 may be distributed in input device 30. A distributed vibrating element may include a plurality of motors and/or transformers configured to generate vibrations to a selectable value.

In an embodiment (an example of which is depicted in FIG. 2), the input device may include a switch 12 to turn the vibrating element(s) 42 on or off. The input device may also include an external control device 14 (e.g., a rheostat) to allow the user to control the amplitude and/or frequency of the vibrations of vibrating element 42. In an embodiment, a vibration sensor 44 may be coupled to microcontroller 38. Microcontroller 38 may be configured to activate and/or shut-off vibrating element 42 based on a signal received from vibration sensor 44. In an embodiment, input device 30 may include vibration sensor 44 to measure the vibration amplitude and/or frequency and send an electrical signal corresponding to the vibration measurement. In an embodiment, computer system 150 may be configured to detect the use of input device 30. When use of input device 30 is detected, computer system 150 may send a signal to turn on vibrating element 42. Turning on vibrating element 42 may be defined as applying or regulating electrical current applied to vibrating element 42. In an embodiment, microcontroller 38 may be configured to detect use of input device 30. In such an embodiment, microcontroller 38 may send a signal to turn on vibrating element 42 when use of input device 30 is detected.

In an embodiment, a computer software program may be configured to control the vibration of input device 30. Computer system 150 may be coupled to input device 30 via cable 162. Computer system 150 may execute the computer software program to control the amplitude and/or frequency of vibrating element 42. In an embodiment, the computer software program may generate a graphical user interface to monitor vibration of the input device 30. The graphical user interface may include a color graphic display on display monitor 154. The graphical user interface may include the present vibration level of input device 30. In an embodiment, the graphical user interface may include a desired or target vibration level of input device 30.

In an embodiment, the software program to control the vibration of input device 30 may be based on simple on/off control. In an embodiment, the software program to control the vibration of input device 30 may be based on proportional/integral/derivative (PID) control. It is understood that other control algorithms (e.g. algorithms based on proportional control, fuzzy logic, adaptive controls, etc) may also be used.

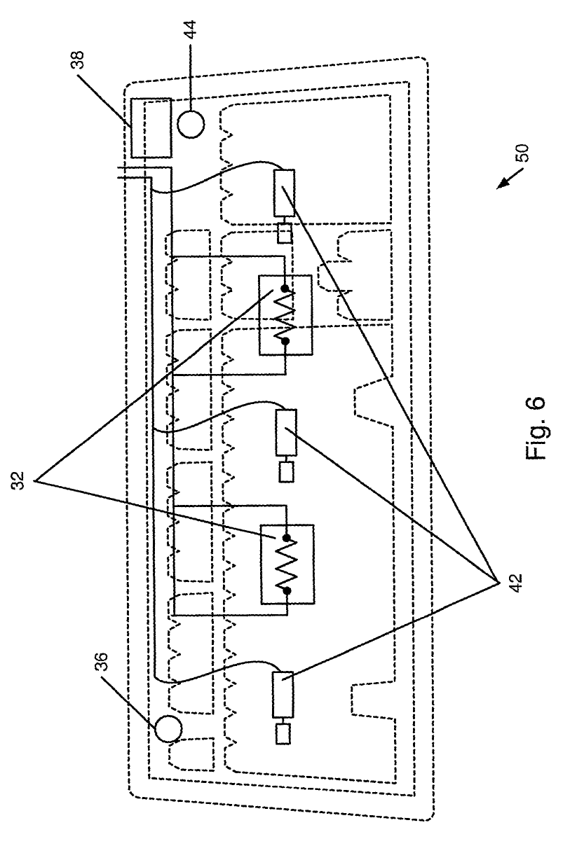

In an embodiment, input device 30 may include both heating element 32 and vibrating element 42. In such an embodiment, both temperature sensor 36 and vibration sensor 44 may be present. For example, FIG. 6 depicts an embodiment of a keyboard 50 having distributed vibrating elements 42, distributed heating elements 32, temperature sensor 36, vibration sensor 44, and microcontroller 38.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A computer input device comprising:
a heating element configured to generate heat, wherein the input device is configured to transfer heat from the heating element to a user of the input device during use.

2. The device of claim 1, further comprising a temperature sensor coupled to the heating element.

3. The device of claim 1, further comprising a microcontroller coupled to the heating element, wherein the microcontroller is configured to control the amount of heat produced by the heating element.

4. The device of claim 1, further comprising a temperature sensor coupled to the heating element and a microcontroller coupled to the heating element, wherein the microcontroller is configured to control the amount of heat produced by the heating element in response to a temperature monitored by the temperature sensor.

5. The device of claim 1, further comprising a temperature sensor coupled to the heating element, wherein the input device is coupled to a computer system such that the computer system is coupled to the heating element, and wherein the computer system is configured to control the amount of heat produced by the heating element in response to a temperature monitored by the temperature sensor.

6. The device of claim 1, wherein the input device is coupled to a computer system, and, wherein power to the heating element is supplied by the computer system.

7. The device of claim 1, wherein the input device comprises an external control device, wherein the external control device is configured to allow a user to alter the heat output of the heating element.

8. The device of claim 1, further comprising a plurality of heating elements, wherein the beating elements are distributed.

9. The device of claim 1, wherein the heating element is centralized.

10. A computer input device comprising:
a vibrating element configured to generate vibrations, wherein the input device is configured to transfer vibrations from the vibrating element to a user of the input device during use.

11. The device of claim 10, further comprising a vibration sensor coupled to the vibrating element.

12. The device of claim 10, further comprising a microcontroller coupled to the vibrating element, wherein the microcontroller is configured to control the amount of vibration produced by the vibrating element.

13. The device of claim 10, further comprising a vibration sensor coupled to the vibrating element and a microcontroller coupled to the vibrating element, wherein the microcontroller is configured to control the vibrations produced by the vibrating element in response to the vibrations monitored by the vibration sensor.

14. The device of claim 10, further comprising a vibration sensor coupled to the vibrating element, wherein the input device is coupled to a computer system such that the computer system is coupled to the vibrating element, and wherein the computer system is configured to control the amount of vibration produced by the vibrating element in response to vibrations monitored by the vibrating sensor.

15. The device of claim 10, wherein the input device is coupled to a computer system, and wherein power to the vibrating element is supplied by the computer system.

16. The device of claim 10, wherein the input device comprises an external control device, wherein the external control device is configured to allow a user to alter the vibration output of the vibrating element.

17. The device of claim 10, further comprising a plurality of vibrating elements, wherein the heating elements are distributed.

18. The device of claim 10, wherein the vibrating element is centralized.

19. A computer input device comprising:
a heating element configured to generate heat, wherein the input device is configured to transfer heat from the heating element to a user of the input device during use; and
a vibrating element configured to generate vibrations, wherein the input device is configured to transfer vibrations from the vibrating element to a user of the input device during use.
